(19) United States
(12) Patent Application Publication
(10) Pub. No.: US 2008/0191594 A1
(43) Pub. Date: Aug. 14, 2008

(54) Electroluminescent Device

(75) Inventors: Matthias Wendt, Wuerselen (DE); Gunnar Luettgens, Aachen (DE); Guenter Lingemann, Eschweiler (DE); Bernd Ackermann, Aachen (DE); Christoph Martiny, Aachen (DE); Georg Sauerlaender, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/912,394

(22) PCT Filed: Apr. 25, 2006
(86) PCT No.: PCT/IB2006/051276

§ 371 Date: Oct. 24, 2007

(30) Foreign Application Priority Data
Apr. 29, 2005 (EP) 05103560.8

(51) Int. Cl. H01J 7/24; H01J 1/62

(52) U.S. Cl. 313/47; 313/498

(57) ABSTRACT

An electroluminescent device (7) comprising at least one electroluminescent light source (2) and at least one electronic component (3) for driving the electroluminescent light source (2), which electronic component (3) is arranged in such a way as to be separated in space from the electroluminescent light source (2), the electrical connection between the electroluminescent light source (2) and the electronic component (3) being made by a flexible film (8) having electrically conductive regions (82) and at least one electrically insulating surface (81).

The invention relates to an electroluminescent device having a flexible conductive film.

Electroluminescent light sources are very effective and are used for a wide range of applications such as for example in the automobile industry, for indicator lights and in other areas. Where applications call for flat devices, electroluminescent light sources are typically arranged directly on a printed circuit board (PCB) carrying the controlling electronics. However, due to the large area of a PCB, the two-dimensional extent of an arrangement of this kind is considerably larger than that of the small electroluminescent light source. In some of the applications an optical system is needed around the electroluminescent light source, such as for example an arrangement of reflectors to guide the beam in automobile headlights. In these cases, the electroluminescent light source can no longer be arranged directly on the PCB because the latter, due to its large dimensions, would get in the way of the optical path. Electrical contact with the PCB is then usually made by means of wires that are soldered to the contacts of the electroluminescent light source (EL light source) and of the PCB. In particular applications, a wired connection of this kind has to run for quite long distances of a few centimeters to reach the PCB. Fractures of the wires or partings of the soldered joints, which are placed under mechanical stress by the not very flexible wires, are one of the main causes of faults in an arrangement of this kind.

In electroluminescent devices that are intended to give a high luminance, the electroluminescent light source has to be cooled to prevent degradation phenomena from occurring during operation. Where mounting is on PCBs, this means that the PCBs have to be structured in a complicated way to ensure adequate heat dissipation from a heat sink arranged in contact with the PCB. In the case of electroluminescent light sources that are arranged in such a way as to be separated in space from the PCB, cooling can be ensured by mounting the electroluminescent light source on the heat sink. However, the method of mounting, typically by means of an adhesive-bonded joint, has to ensure that the electroluminescent light source is electrically insulated from the heat sink. This is usually achieved by means of a layer of adhesive of the appropriate thickness. However, for good cooling it would be desirable for the layer between the heat sink and the electroluminescent light source to be as thin as possible.

It is therefore an object of the invention to provide an electroluminescent device, having a PCB and an electroluminescent light source that are separated from one another in space, that is notable for a long working life, a low fault rate and the simplified way in which it can be fitted.

This object is achieved by an electroluminescent device comprising at least one electroluminescent light source and at least one electronic component for driving the electroluminescent light source, which electronic component is arranged in such a way as to be separated in space from the electroluminescent light source, the electrical connection between the electroluminescent light source and the electronic component being made by a flexible film having electrically conductive regions and at least one electrically insulating surface. The avoidance of wires that have to be soldered on to make electrical contacts allows the reliability of the light source over its working life to be increased while at the same time providing flexibility in respect of fitting to any desired electroluminescent devices configured in three dimensions. In this case the electronic component may comprise a power supply and/or a PCB.

Flexible conductive films having a layer system comprising an upper and lower polyamide film and an electrically conductive copper core (also referred to as an electrically conductive region) are known for connecting elements that are separated in space to allow the number of components involved, and particularly plug-and-socket connections, to be reduced. The person skilled in the art is not given any hints in the prior art suggesting the use of these films in electroluminescent devices, particularly to avoid wire fractures caused by mechanical stresses in electroluminescent devices.

It is advantageous if the flexible film is suitable for making appropriate thermal contact between a heat sink and the electroluminescent light source. Electroluminescent light sources for applications in which high luminance is required need to be well cooled to prevent heat-induced degradation phenomena from occurring.

It is particularly advantageous if the flexible film is of a thickness of less than 60 μm. Thermal conductivity through the flexible film depends on, amongst other things, the thickness of the flexible film as a layer.

It is even more advantageous if the thickness of the conductive regions of the flexible film is more than 40% of the thickness of the flexible film. The thermal conductivity through the film increases with the proportion that the thickness of the conductive regions represents of the thickness of the flexible film. What are quite particularly advantageous in this case are conductive regions made of at least one material from the group comprising copper, silver and gold, because these elements, as well as having good electrical conductivities, also have very high thermal conductivity.

It is also advantageous if the flexible film is intended for the application of a voltage equal to or less than 60 V. Because of the low operating voltages of electroluminescent light sources, the design of the film can be better optimized for thermal conductivity characteristics.

In a preferred embodiment, the electronic component is arranged on the flexible film. In a particularly preferred embodiment, the flexible film is arranged at least partly on a heat sink, by which means the items arranged on the film, such as the electronic component for example, can be cooled.

In a very particularly preferred embodiment, the flexible film is arranged between the electroluminescent light source and the heat sink. What is obtained in this way between the heat sink, which is typically made of metal, and the electroluminescent light source is on the one hand electrical insulation and on the other hand a thermally conductive connection. The cooling of the electroluminescent light source is proportional to the thickness of an intervening layer between the heat sink and the electroluminescent light source. What are typically used to insulate the electroluminescent light source electrically and at the same time to fasten it in place are layers of adhesive of thicknesses of more than 100 μm. This being the case, flexible films are advantageous as a means of making thermal contact due to their small thickness.

It is advantageous in this case if an adhesion layer suitable for fastening the flexible film to a heat sink is arranged on the insulating surface of the flexible film. In this way the electroluminescent device can be fastened easily to a body of three-dimensional configuration, and preferably to a heat sink.

In a further preferred embodiment the flexible film comprises at least one first region of a first thickness, for the application of the electronic component, and at least one second region, of a second thickness smaller than the first thickness, for the application of the electroluminescent light source. It can be ensured in this way that reliable connections will be made to the electronic component without any risk of the flexible film breaking or tearing.

In a particularly preferred embodiment, at least one electronic component is incorporated in the flexible film.

These and other aspects of the invention are apparent from and will be elucidated with reference to the embodiments described hereinafter.

In the drawings:

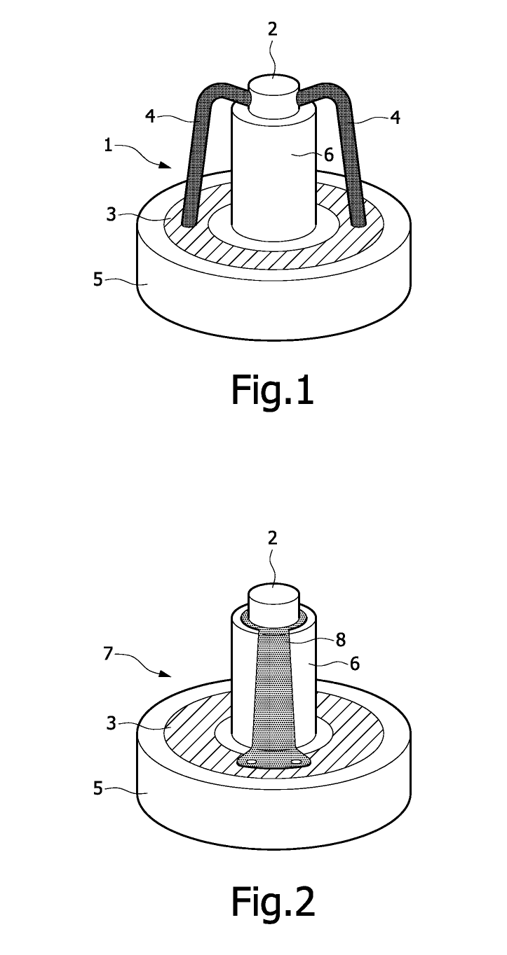

FIG. 1 shows a prior art electroluminescent device.

FIG. 2 shows an electroluminescent device according to the invention having a flexible film.

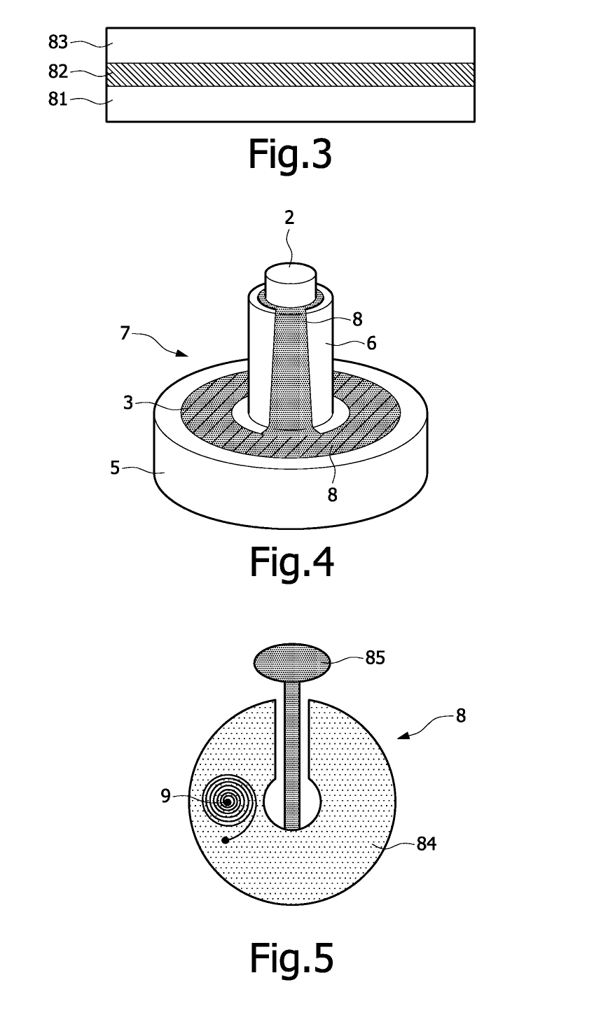

FIG. 3 is a cross-section through the flexible film.

FIG. 4 shows a further embodiment of the electroluminescent device according to the invention.

FIG. 5 shows a further embodiment of the flexible film.

FIG. 1 shows a prior art electroluminescent device 1 in which the electrical connection between an electronic component 3, typically controlling electronics produced in the form of a PCB, and the electroluminescent light source 2 is made by means of soldered-on wires 4. Conditions may be set for the separation in space between the electroluminescent light source 2 and the electronic component 3 by special optical requirements that the device has to meet, such as for example the need for a mirror system arranged around the electroluminescent light source for guiding the beam in automobile headlights. The electronic component 3 and the electroluminescent light source 2 are arranged on bodies 5 and 6 that, depending on the design, may take the form of one or more heat sinks. In applications where high luminance is required, at least the body 6 has to be a heat sink so that the heat generated during the operation of the electroluminescent light source 2 can be dissipated to an adequate extent to prevent the latter's emission characteristics from being degraded.

In contrast to what is shown in FIG. 1, an electroluminescent device of this kind may also comprise more than one electroluminescent light source. What are also possible are other forms for the bodies 5 and 6 and other arrangements of the electronic component 3 and the electroluminescent light source 2 in space.

FIG. 2 shows an electroluminescent device 7 according to the invention in which the electrical connection between the electronic component 3, typically controlling electronics produced in the form of a PCB, and the electroluminescent light source 2 is made by means of a flexible film 8 that has conductive regions and at least one electrically insulating surface. The flexible film is connected to the electronic component 3 in the present case by, for example, a soldered connection. The connection of the electroluminescent light source 2 to the flexible film 8 may for example likewise be made by soldering. The electroluminescent light source 2 may in this case also be applied directly to the flexible film 8, which means as well as providing the electrical drive, the film 8 also ensures that the bottom of the electroluminescent light source is electrically insulated from a body 6, which is for example produced in the form of a metal heat sink. In other embodiments, the flexible film may have a cutout below the electroluminescent light source.

The films that are used to reduce the number of components, such as plug-and-socket connections for example, are usually very stiff and thick, being typically of a thickness of between 80 μm and 120 μm, which makes it difficult for such films to be applied to highly structured supporting surfaces. An example of the construction of a flexible film 8 is shown in FIG. 3. The film comprises a conductive metal core 82 that is electrically insulated from the surroundings by means of surfaces 83 and 81. The metal core is typically produced in the form of a thin layer of a thickness of between 17.5 μm and 35 μm. The thicknesses of the surfaces 81 and 83 are typically between 12.5 μm and 25 μm. Because, in contrast to other applications, only low drive voltages of less than 60 V are required to operate electroluminescent light sources, both the surfaces 81 and 83 and also the conductive core 82 can be made thinner, thus enabling films 8 according to the invention to be produced in a particularly advantageous thickness equal to or less than 60 μm. The conductive core may be structured in this case and may thus comprise, for example, individual, flat conductors that are separate from one another. By suitable structuring it may also be made possible for connections to be made to more than one electroluminescent light source.

In a preferred embodiment, to allow the thermal conductivity through the film to be increased, the thickness of the conductive metal core in the flexible film 8 is more than 40% of the thickness of the flexible film 8 (meaning the sum of the thicknesses of the surfaces 81 and 83 and of the metal core 82). To further increase the thermal conductivity, it is advantageous if the metal core is composed of materials having a high thermal conductivity, such as for example copper, silver or gold, which have thermal conductivities of between 3.1 W/(cm×K) and 4.3 W (cm×K) at 300 K. The metal core may comprise one or more of these materials in this case.

FIG. 4 shows an embodiment that is particularly preferred over FIG. 2 because in this case the electronic component too is arranged on the flexible film and there is thus no need for any subsequent connection of the film to the electronic component. The advantage of an arrangement of this kind is that all the electrical connections are made before the electroluminescent device 7 is mounted on a body 5 and/or 6 that is configured in three dimensions.

As shown in FIG. 5, the flexible film 8 is produced in a form in which it is prepared for application to bodies configured in three dimensions. The surface produced is more or less plane before it is fitted to bodies of this kind and the electronic component 3 and the electroluminescent light source 2 can be connected to the flexible film 8 at this surface by a considerably simpler process than would be the case if this had to be done after fitting to bodies 5 and 6 configured in three dimensions.

In a preferred embodiment the flexible film 8 has in this case at least one first region 84 of a first thickness and at least one second region 85 of a second thickness that is less than the first thickness. It becomes possible in this way on the one hand for reliable connections to be possible to the electronic component without the risk of the flexible film breaking or tearing in the first region and also for an electroluminescent light source to be arranged in the second region in good thermal contact with a body 6 in the form of a heat sink. The minimum thickness of the second region having an insulating surface 81 is set by the requirement for the electroluminescent light source 2 and the electrically conductive core 82 in the flexible film 8 to be electrically insulated from the body 5 and/or the body 6. The second region 85 of the flexible film 8 extends at least over the region between the electroluminescent light source 2 and the body 6. However, as shown in FIG. 5, the second region may also extend over other regions of the flexible film 8.

In a particularly preferred embodiment, there is incorporated in the flexible film 8, in addition to the flat conductors for making connections to the electroluminescent light source 2 (not shown in the drawings), at least one electronic component 9, such as a coil for example, see FIG. 5.

The embodiments which have been elucidated by means of the drawings and description are only examples of an electroluminescent device according to the invention and are not to be construed as limiting the claims to these examples. For the person skilled in the art, there are also alternative embodiments that are possible, and these too are covered by the scope of protection afforded by the claims. The flexible film may also be of other geometries that are not shown here, for bodies of different configurations and for different arrangements that comprise more than one electronic component and more than one electroluminescent light source. The numbering of the dependent claims is not intended to imply that other combinations of the claims do not also represent advantageous embodiments of the invention.

1. An electroluminescent device (7) comprising at least one electroluminescent light source (2) and at least one electronic component (3) for driving the electroluminescent light source (2), which electronic component (3) is arranged in such a way as to be separated in space from the electroluminescent light source (2), the electrical connection between the electroluminescent light source (2) and the electronic component (3) being made by a flexible film (8) having electrically conductive regions (82) and at least one electrically insulating surface (81).

2. An electroluminescent device as claimed in claim 1, characterized in that the flexible film (8) is suitable for making appropriate thermal contact between a heat sink (6) and the electroluminescent light source (2).

3. An electroluminescent device as claimed in claim 1, characterized in that the flexible film (8) is of a thickness of less than 60 μm.

4. An electroluminescent device as claimed in claim 3, characterized in that the thickness of the conductive regions (82) of the flexible film (8) is more than 40% of the thickness of the flexible film (8).

5. An electroluminescent device as claimed in claim 3, characterized in that the conductive regions (82) are composed of at least one material from the group comprising copper, silver and gold.

6. An electroluminescent device as claimed in claim 1, characterized in that the flexible film (8) is intended for the application of a voltage equal to or less than 60 V.

7. An electroluminescent device as claimed in claim 1, characterized in that the electronic component (3) is arranged on the flexible film (8).

8. An electroluminescent device as claimed in claim 1, characterized in that the flexible film (8) is arranged at least partly on a heat sink (6).

9. An electroluminescent device as claimed in claim 1, characterized in that the flexible film (8) is arranged between the electroluminescent light source (2) and the heat sink (6).

10. An electroluminescent device as claimed in claim 1, characterized in that an adhesion layer suitable for fastening the flexible film (8) to a heat sink (6) is arranged on the insulating surface (81) of the flexible film (8).

11. An electroluminescent device as claimed in claim 1, characterized in that the flexible film (8) comprises at least one first region (84) of a first thickness, for the application of the electronic component (3), and at least one second region (85), of a second thickness smaller than the first thickness, for the application of the electroluminescent light source (2).

12. An electroluminescent device as claimed in claim 1, characterized in that at least one electronic component (9) is incorporated in the flexible film (8).
